(19) United States
(12) Patent Application Publication
(10) Pub. No.: US 2009/0011397 A1
(43) Pub. Date: Jan. 8, 2009

(54) METHOD, SYSTEM AND DEVICE FOR MANAGING COMPENSATED EDUCATIONAL INTERACTION

(76) Inventor: Greg Writer, Escondido, CA (US)

Correspondence Address: ADVANTIA LAW GROUP, 9035 SOUTH 1300 EAST, SUITE 200, SANDY, UT, 84094, US

(21) Appl. No.: 12/167,029

(22) Filed: Jul. 2, 2008

Related U.S. Application Data
(60) Provisional application No. 60/947,616, filed on Jul. 2, 2007.

(51) Int. Cl. G09B 3/00

(52) U.S. Cl. 434/350

(57) ABSTRACT

A method of managing compensated education on a computing platform, includes the steps of: providing compensated educational interaction over a computing platform thereby enabling a user to earn compensation for an educational interaction, collecting interaction data regarding the compensated educational interaction from the computing platform thereby generating collected interaction data, and providing an information set based on the collected interaction data thereby allowing an information set receiver to act based on the substance of the information set.

### CROSS-REFERENCE TO RELATED APPLICATIONS

This invention claims priority, under 35 U.S.C. §120, to the U.S. Provisional Patent Application No. 60/947,616 to Greg Writer filed on 2 Jul. 2007, which is incorporated by reference herein.

### FIELD OF THE INVENTION

The present invention relates to systems, methods, and devices for providing educational interaction, specifically managing compensated educational interaction.

### DESCRIPTION OF THE RELATED ART

Education is a key to unlock individual and societal potential. To the uneducated individual the world is closed and confusing. To the educated individual the world is open to a myriad of possibility. With education societies often flourish, and societies often fall from the lack thereof. In sum, education is a critical endeavor to the human experience.

One goal of education is to help individuals become successful members of society. Indeed, many programs have been developed to help foster this success. In particular, many have developed games to facilitate learning.

In addition, people have tried to enhance education through a number of means including, but not limited to: introducing technology into the classroom, providing teacher training, producing educational television, manufacturing educational toys, and providing compensation for education. Compensation might include, but is not limited to, providing enjoyable food, providing money, or providing extra recreational time.

Several publications, references and patents have been directed towards educational games, money management, or data collection, some of which are listed below, and incorporated by reference herein for their supportive teachings:

U.S. Pat. No. 7,117,173 to Ambani discloses a system and method of providing financial services to children with a child-friendly user-interface that includes an age-appropriate integrated financial services account statement having links to multimedia files providing information on or related to specific assets listed in the statement. The system and method may also be used as a way of giving gifts to a child, and as a portal to a variety of child-related services and products.

U.S. Pat. No. 6,890,179 to Rogan et al. discloses an electronic media for teaching financial principles including an interactive game that includes a financial lesson. The interactive game may be remotely accessed by users via a network such as the Internet. In certain embodiments the interactive game includes (i) a lesson portion; (ii) a game play portion; and, optionally, (iii) a lesson reinforcement portion. In other embodiments the interactive game includes one or more rewards for successfully completing each interactive game. Such rewards may include a certificate of achievement and/or access to an otherwise inaccessible game.

U.S. Pat. No. 6,729,884 to Kelton et al. discloses an Internet-based game for teaching personal values and financial responsibility to a child including interactive game events, an adventure story activity with selectable story elements, a scoring system awarding a virtual collectible creature having artificial intelligence characteristics and characteristics mimicking a financial instrument, and indicia of account information.

U.S. Pat. No. 6,224,381 to Culberson et al. discloses an apparatus for educating special needs children about money including an easel having a display page having ferromagnetic properties arranged to display the display page to a child and specimen money and a plurality of graphics cards having magnetic properties adapted for mounting on the display page. The graphics cards include a first money card having numeric depictions stating values of money so the child can place corresponding money on the display page in association with the numeric depictions, a second money card having depictions of various ones of the money so that the child can place several items of money on the graphics card of lesser value than the depicted money to arrive at the value of the depicted money, and a third money card having numeric depictions stating various values, so that the child can place several items of money of lesser value than the numeric depiction to arrive at the value of the numeric depiction. Also, budget cards with budget category identifiers and an amount for the budget category are included, so that the child can place money on the display page for the amount for the budget category.

Additional examples include: U.S. Pat. Nos. 6,086,381, 5,743,746, 5,035,625; and U.S. Patent Publication Nos. 2006/0155617, 2005/0079471, 2004/0081942, 2004/0076931, and 2003/0212636, which are each incorporated by reference herein for their supporting teachings.

The inventions heretofore known suffer from a number of disadvantages which include: failing to provide: enhanced intelligence and control to parents, key information to educational professionals, feasible business models revolving around education, enjoyable educational experiences, customized learning experiences, and strategic partners with key information configured to enhance the educational experiences; and failing to adequately motivate learners.

Systems, methods and/or devices are needed for managing compensated education that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available educational methods, systems, and devices. Accordingly, the present invention has been developed to provide methods, systems, and devices for managing compensated educational interaction.

In a first implementation, a method of managing compensated education on a computing platform, includes one or more of the steps of: providing compensated educational interaction over a computing platform thereby enabling a user to earn compensation for an educational interaction, collecting interaction data regarding the compensated educational interaction from the computing platform thereby generating collected interaction data, and providing an information set based on the collected interaction data thereby allowing an information set receiver to act based on the substance of the information set.

One or more of the following features may be included in an embodiment of the invention.

The step of providing compensated educational interaction may further include providing a standard interface protocol configured to permit a third-party to provide educational content to the user over the computing platform such that the user may be compensated for interactions therewith. The step of providing compensated educational interaction may include providing an offline interaction module configured to permit a user to register offline educational interactions and be compensated thereby. The offline interaction module may further include a reminder module configured to remind a user to perform a specific offline activity. The step of providing compensated educational interaction may further include filtering input from a user thereby protecting the user from harmful interaction. The step of filtering input from a user may further include a personal information filtering module configured to identify personal information input from the user and filter such. The step of providing compensated educational interaction may further include a plurality of educational interactions each having adjustable compensation which may be selected. The step of providing compensated educational interaction may further include altering compensation for an educational interaction according to a received information set. The step of providing compensated educational interaction may further include altering compensation for an educational interaction for an administered account module according to an instruction received from an administrative account module. The step of providing compensated educational interaction may include displaying a compensation value in association with a displayed activation module configured to initiate an associated compensated educational interaction.

The step of providing an information set may further include providing the information set to a user of an administrative account module having control over an account module of the user from whose interactions generated the information set. The administrative account module may include a messaging module configured to permit a user of the administrative account module to deliver a message to an administered account. The information set may include a suggested message to be delivered by the messaging module.

In another implementation, a computing system for managing compensated education of users, includes one or more of the following: a compensation module configured to provide compensated educational interaction thereby enabling a user to earn compensation for an educational interaction, a data collection module in communication with the compensation module and configured to collect interaction data regarding the compensated educational interaction provided by the compensation module thereby generating collected interaction data, and a data distribution module in communication with the data collection module and configured to provide an information set based on the collected interaction data collected through the data collection module thereby allowing an information set receiver to act based on the substance of the information set.

One or more of the following features may be included in an embodiment of the invention. The compensation module may be one of the following modules: a virtual bank module, a virtual investment module, a virtual auction module, an educational audio/video module, an offline interaction module, an educational games module, and a content protocol module. The data distribution module may provide the collected interaction data to an administrative account module in communication with the compensation module. The offline interaction module may further include a reminder module configured to remind a user to perform a specific offline activity. The administrative account module may further include a messaging module configured to permit a user of the administrative account module to deliver a message to an administered account. The compensation module may further include a filtering module configured to filter input from a user thereby protecting the user from harmful interaction.

In another implementation, a computer-readable medium includes computer-executable instructions that, when executed, direct a computer to perform one or more of the steps of: providing compensated educational interaction, including providing a standard interface protocol configured to permit a third-party to provide educational content to the user, thereby enabling a user to earn compensation for an educational interaction; collecting interaction data regarding the compensated educational interaction from the computing platform thereby generating collected interaction data; and providing an information set based on the collected interaction data thereby allowing an information set receiver, including a user of an administrative account module having control over an account module of the user from whose interactions generated the information set, to act based on the substance of the information set.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of a system of managed compensated education, according to one embodiment of the invention;

FIG. 2 is a top-level operation diagram illustrating a flow and exchange of virtual token (s), according to one embodiment of the invention;

FIG. 3 illustrates a relational diagram of a system, method and device of managing compensated education, according to one embodiment of the invention;

FIG. 4 is a top-level operation diagram illustrating a flow and exchange of data, according to one embodiment of the invention;

FIG. 5 is a top-level operation diagram illustrating a flow and exchange of data, according to one embodiment of the invention;

FIG. 6 is a flowchart of a method of managing compensated education, according to one embodiment of the invention;

FIG. 7 is a flowchart of a method for managing compensated education, according to one embodiment of the invention;

FIG. 8 is a block diagram of a system of managing compensated education, according to one embodiment of the invention; and

FIG. 9 illustrates an exemplary screen-shot of a user interface for selecting educational interactions in a system for managing compensated education, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. Various databases used herein may include: game data, activity data, survey data, audio/video data, auction data, investment data, banking data, user data, account data; and/or like data useful in the operation of the present invention. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

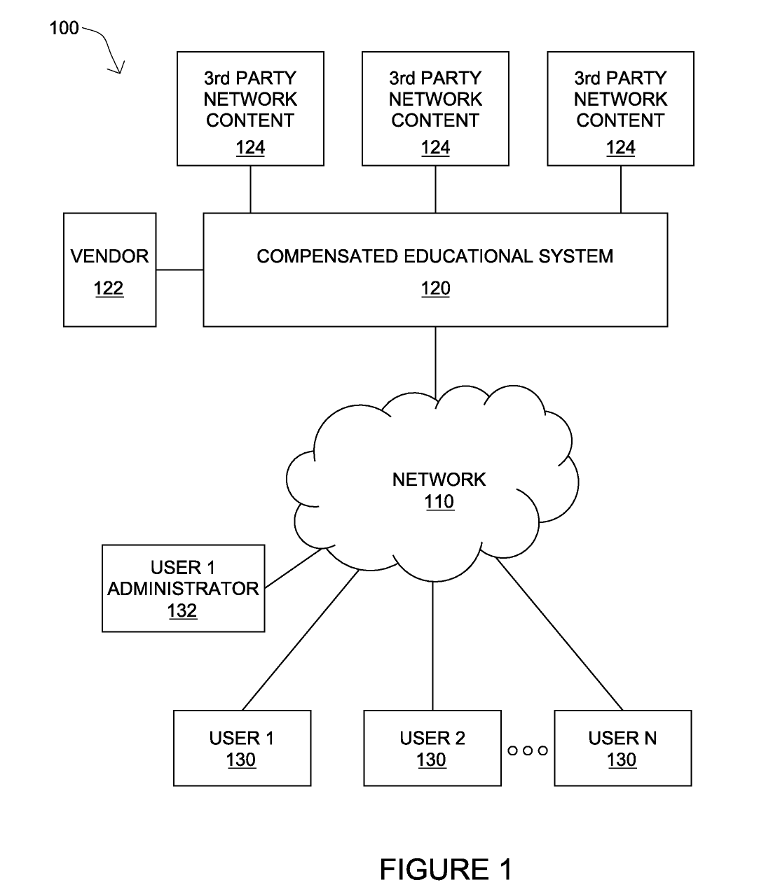

FIG. 1 is a network diagram of a system of managed compensated education, according to one embodiment of the invention. There is shown compensated education system 120 in communication with a plurality of users 130 over network 110. User administrator 132 is also shown in communication with compensated education system 120 over network 110. User 130, and user administrator 132 may also be connected directly to compensated education system 120. User 130 may be a student, a child, or another interested party. User administrator 132 may be a teacher, a parent, or any other party interested in user 130.

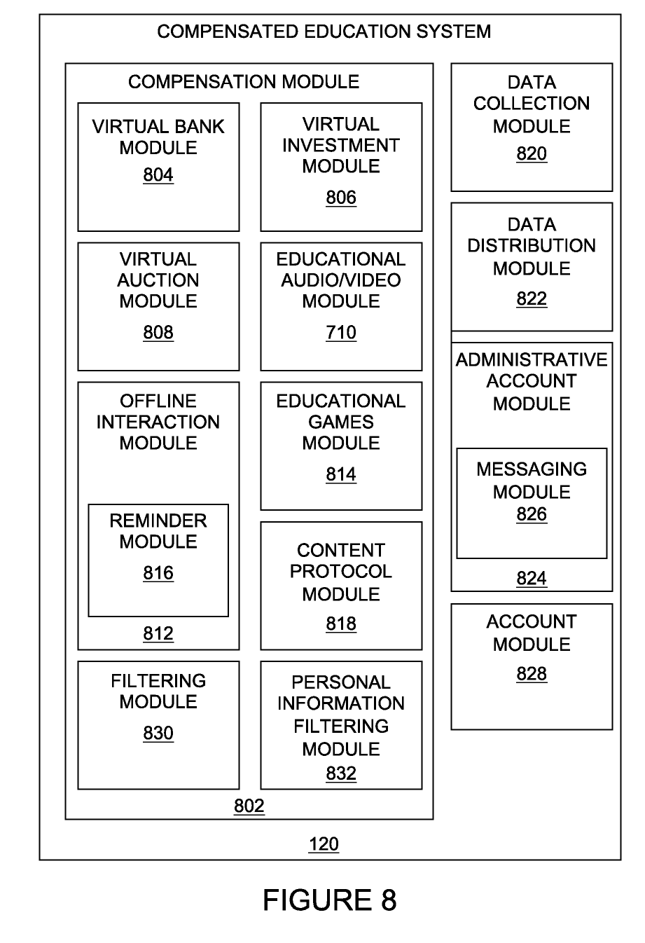

As shown in FIG. 1 the system may also include third party network content 124. Third party content 124 may be connected directly to compensated education system 120 or in communication with compensated education system 120 over network 110. Third party network content 124 may be embodied as links/hyperlinks in compensated education system 120 to the third party network content and/or may be incorporated in to the content of compensated education system 120. Additionally, third party network content may comprise content which has been incorporated into and/or added on to the content already in compensated education system 120, such as, but not limited to, modules shown within compensation module 802 in FIG. 8. In a non limiting example, educational games module 814 may include third party education games, puzzles, etc. A third party entity such as Viacom International, Inc., Mattel, Inc., Electronic Arts, Inc., and/or other games, puzzles supplier may desire to incorporate one or more games/puzzles into compensated education system 120.

As shown in FIG. 1 the system may also include vendor 122. Vendor 122 may be connected directly to compensated education system 120 or in communication with compensated education system 120 over network 110. Vendor 122 may receive collected data. A vendor may or may not also be a third party network content provider.

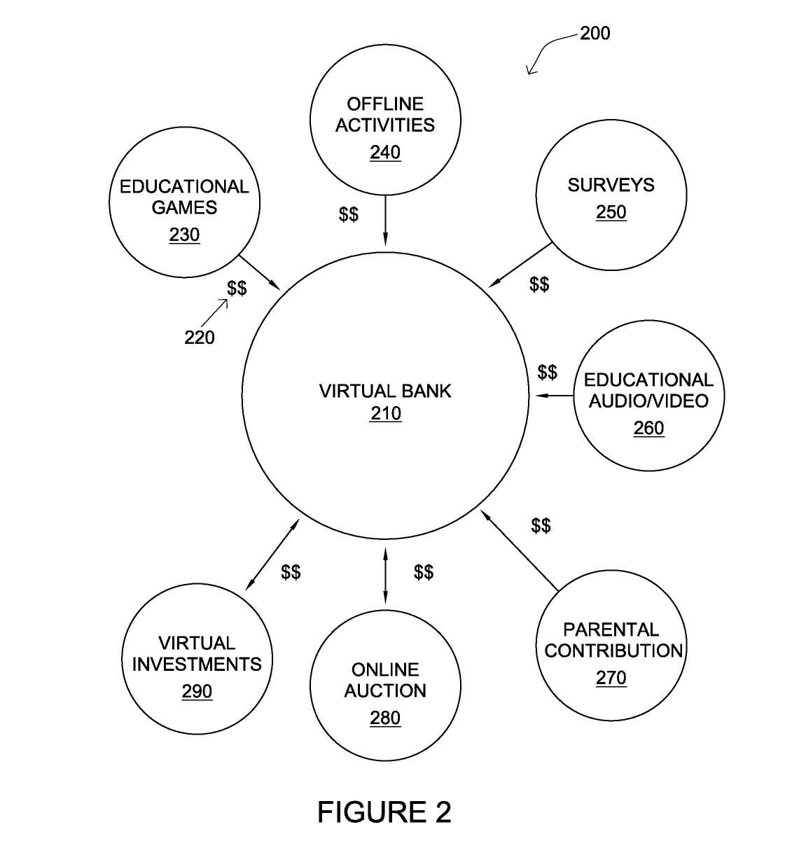

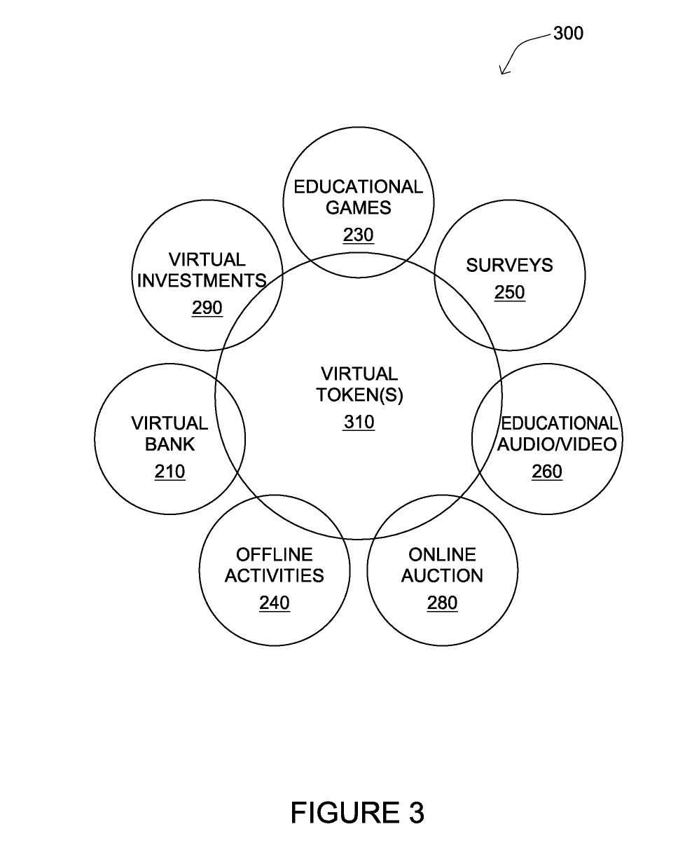

FIGS. 2 and 3 illustrate top-level operation and relational diagrams of a system, method and device of managing compensated education according to one embodiment of the invention. In particular, FIG. 2 is a top-level operation diagram illustrating a flow and exchange of virtual token(s), according to one embodiment of the invention. In a related manner, FIG. 3 illustrates a relational diagram of a system, method and device of managing compensated education, according to one embodiment of the invention. A virtual token 310 may be any type and/or kind of virtual token contemplated in the art, such as but not limited to coins, money, written currency, checks, virtual credit and/or credit cards, debit and/or debit cards, bartering, and/or so forth. As illustrated, the one or more virtual tokens may be associated with, but not limited to: educational games 230, surveys 250, virtual investments 290, virtual bank 210, online auction 280, educational audio video 260, and/or offline activities. There may also be a parental contribution 270 which deposits virtual tokens 310 into virtual bank 210. In being associated with the above described features, the one or more virtual tokens may or may not be exchanged upon one or more users' involvement with the above described features, as shown with virtual token flow arrows 220, and as described in this disclosure.

Educational games 230 may include one or more of any type of games contemplated in the art, such as but not limited to puzzles, single/multi player games, role playing games, action games, strategy, board games, and/or so forth. Educational games 230 may include one or more educationally related and/or based games, or games whose primary function is to promote learning and/or education during game play. The one or more games may include features which assist in a variety of educational topics such as but not limited to, art, history, finance, language literacy (i.e., English, Spanish, etc.) and/or grammar, math, science, health, social studies, and//or so forth. Indeed, a user (and/or his or her parent) may select which type of game he or she wishes to play. Therefore, if a user is having difficulty in a specific area of study/education, he or she may select a game related to that area. The game may be any type and/or kind of game contemplated in the art, such as but not limited to those taught in U.S. Pat. Nos. 7,086,865, 6,648,648, which are incorporated by reference herein for their supportive teachings.

Educational audio/video 260 may include audio and/or video clips, presentations, and/or data to which a user may be given access. Educational audio/video may additionally include awarding one or more virtual tokens 310 after a user views, interacts with, and/or downloads one or more audio/video presentations. The one or more virtual tokens 310 may then be deposited in a user's 130 virtual bank 210 and/or user's 130 bank account. The audio/video clips and/or presentations may be any type and/or kind of audio/video contemplated in the art. In a non-limiting example, there may be one or more educational video and/or audio clips which teach and/or inform kids/users. Additionally, there may be images which may be informative and/or educational and a user may or may not be awarded a virtual token based on usage, interaction, etc.

Online auction 280 may function to provide an auction system wherein one more users may exchange his or her virtual tokens for items, goods, services, etc. The auction module may be any type and/or kind of auction module contemplated in the art, such as but not limited to those taught in U.S. Patent Publication No. 20030154134 and 20070022040, which are incorporated by reference herein for their supportive teachings.

In an alternative embodiment, a system and method of educating and network interaction while collecting data may include an shopping module and/or shopping section wherein a user may instead of auctioning and/or bidding for items, he or she may simply want to purchase the item. Indeed, the shopping and/or auction modules may be combined/integrated wherein an item may be up for bid, with a bidded price, and a buy-now price. The user may be given the option to either bid in the auction or simply exchange his or her virtual tokens immediately for the item.

In one embodiment, there may be a variety of goods/services/items included as part of the auction for which a user may or may not be able to exchange virtual tokens. Some non-limiting examples of items include: toys, games, books, video/dvd, art/school supplies, cards, trading cards, etc. The items may be acquired from the 3^{rd} party vendors, wholesalers, donors, etc.

In an additional embodiment online auction 280 may include a market testing section wherein new products/services may be auctioned up and data/information regarding the sale/auction of one more items may be tracked and/or recorded, and/or sent to the manufacturer, retailer, or provider of the product/service. In this manner, actual and current market information may be obtained by simply putting the product/service into the auction system. A product/service manufacturer, retailer, or provider may be able to gauge and/or determine marketability by the demand for the product/service in the auction.

In another embodiment, a user may be able to post and/or place items in online auction 280. Thus, the items up for bid/purchase in the system may originate from a user in the system. Other users may then bid and/or purchase those items and the user who posted the item would receive those virtual tokens.

Virtual bank 210 may be associated with and/or be involved in the exchange of virtual tokens 310 between all of the other aspects and/or features of the system. The virtual bank 210 may function to manage, receive, distribute, administer, and/or display one more virtual tokens 310 associated with and/or included in and/or owner by a user's account. The virtual bank 210 system/module may include any features, components, and/or characteristics contemplated in the art, or that would be associated with a bank, such as but not limited to: account balance, interest, withdrawals, deposits, account owner/user information, investments. Additionally, virtual bank 210 may include a variety of user initiated functions such as but not limited withdrawal, deposit, transfer, and/or displays, screens and/or graphical user interfaces (GUI) associated with those user initiated actions. The virtual bank system/module may be any type and/or kind of network bank and/or software contemplated in the art, such as but not limited to those taught in U.S. Patent Publication Nos. 20040078326 and 20020138432, which are incorporated by reference herein for their supportive teachings.

Virtual investments 290 may be in communication with virtual bank 210, and may function to enable one or more users to invest and/or save virtual tokens from their account in virtual bank 210. The investment savings system may or may not be in communication with one or more actual stock exchanges, such as but not limited to, the NASDAQ, the Dow, the S&P, and/or so forth. Virtual investments 290 may or may not include displays and/or an actual stock updates and/or information regarding stock prices/exchange rates, news and information regarding companies, and/or so forth. Indeed, the investment data may be embodied as hyperlinks and/or network links to actual stock web pages and/or be displayed on a system network page. In a non-limiting example, a user who has purchased stock may select to have that stock price and/or information regarding his or her stock portfolio displayed on his or her account information page, for example, in the virtual bank account page.

User 130 may be awarded virtual tokens 310 for offline activities 240, or activities accomplished and/or conducted outside of the system. Offline activities 240 such as, but not limited to community service, receipt and/or earning of awards, school and/or community awards and/or grades, participation in community, school and/or cultural events, and/or so forth. In a non-limiting example, a user may submit his or her report card and/or progress report, which may the user may then be awarded one or more token(s).

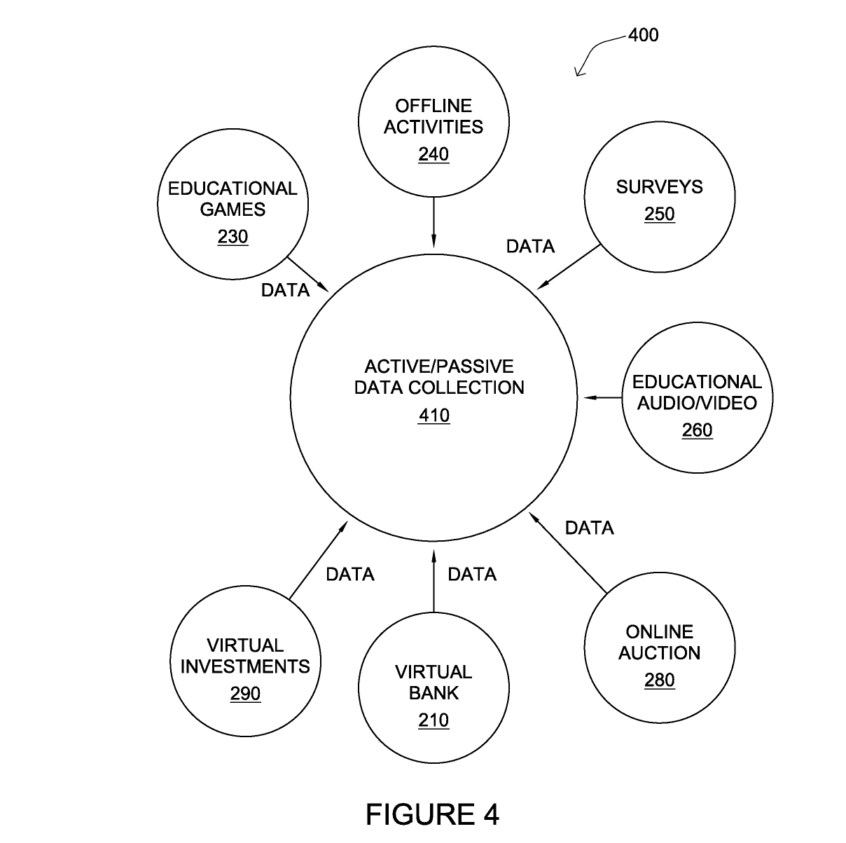

FIG. 4 is a top-level operation diagram illustrating a flow and exchange of data, according to one embodiment of the invention. Compensated education system 120 collects compensated educational interaction data regarding the compensated educational interaction. In a non-limiting example, educational interaction includes: educational games 230, offline activities 240, surveys 250, educational audio/video 260, online auction 280, virtual bank 210, and/or virtual investment 290. Active/passive data collection 410 may receive data from such educational interaction. In being passive data collection, data may be passively recorded and/or tracked from users based on their participation in the system, as described in this disclosure. In being active data collection, data may be actively collected from one or more users via surveys, emails, etc.

Surveys 250 may function to actively and/or passively collect data from users. Surveys 250 may be any type and/or kind of survey contemplated in the art, such as but not limited to online surveys, mail based and/or phone based surveys, and/or so forth. The subject matter of the survey 250 may vary greatly and may include any questions, features, etc. as contemplated in the art. In a non-limiting example, a survey 250 may or may not be geared toward and/or associated with topics and/or subject matter with which one or more users have interest. Additionally, as illustrated, surveys 250 may be associated with active/passive data collection 410.

Surveys 250 may be associated with virtual tokens 310 and/or the exchange of virtual tokens 310. In a non-limiting example, user 130 may receive and/or be awarded one or more virtual tokens 310 upon his or her involvement with a survey. A user may receive virtual tokens 310 by taking and/or completing a survey 250. Additionally, user 130 may receive virtual tokens 310 by assisting in taking and/or completing a survey 250, such as referring a friend and/or 3^{rd} party to a survey 250 or doing the survey 250. A survey module may be any type and/or kind of survey module contemplated in the art, such as but not limited to U.S. Pat. Nos. 6,406,302 and 6,189,029, which are incorporated by reference herein.

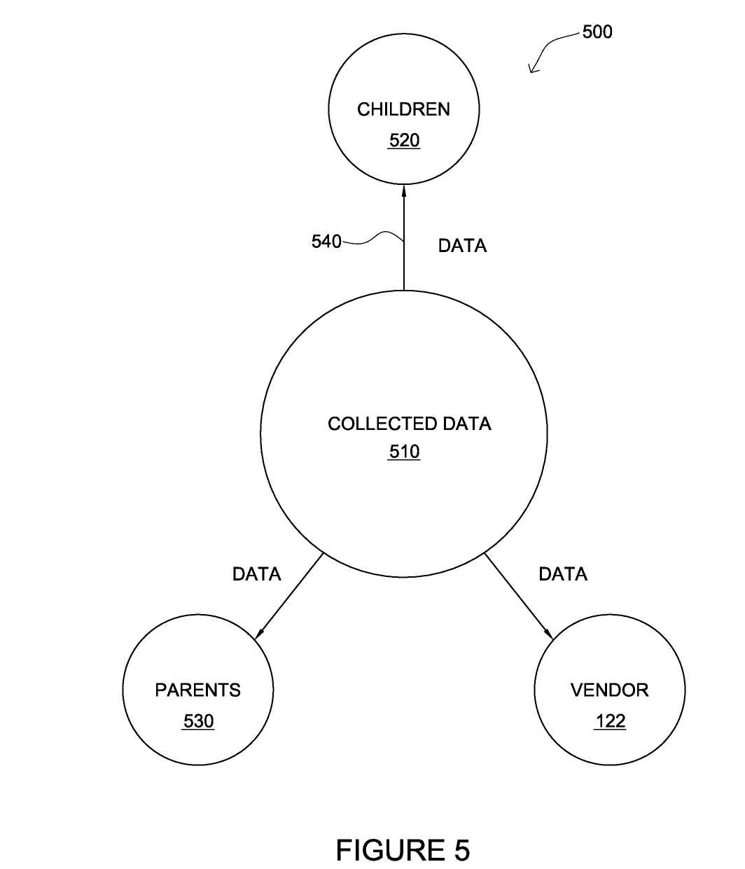

FIG. 5 is a top-level operation diagram illustrating a flow and exchange of data, according to one embodiment of the invention. Compensated education system 120 distributes compensated educational interaction data. In a non-limiting example, data may flow 540 from collected data 510 to children 520, parents 530, and/or vendor 122. In one embodiment children 520 may be users 130, and parents may be user administrators 132.

The following are examples or prophetic examples of the embodiment:

A parent, as an administrative user, logs on to the system to view child's user account. The parent obtains collected data 510 by viewing the child's great progress in memorizing multiplication tables through a game. The parent also checks other subjects and increases the amount the child will be paid for spelling related educational interactions. Before logging off the parent also notices that the child is struggling in geography both as reflected by the system and the child's recent school grades. The parent, using the information, decides to get a geography tutor for the child.

A user obtains collected data 510 regarding recent purchases made through an online auction. Realizing that a purchased product has shipped but has not yet arrived, the user calls the shipping company. While logged on the user also views an aggregated graph of investments, purchases, and income. The child by viewing the graph realizes the importance of investing and commits to redirect some income away from purchases and towards investments.

A vendor who is also a third party network content provider obtains collected data 510 regarding the effectiveness of the vendor's third party network content in teaching geography. The data shows that while vendor's third party network content is often utilized by users, the use of the third party network content doesn't amount to an increased understanding of the geography that it teaches. Based on this information, the vendor alters the third party network content to be more effective in teaching geography.

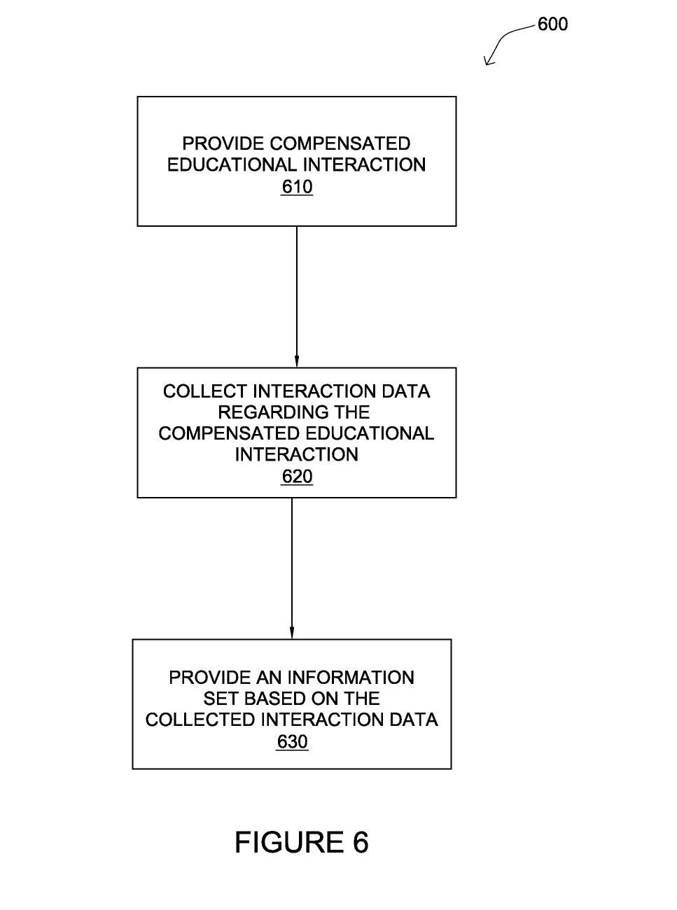

FIG. 6 is a flowchart of a method of managing compensated education, according to one embodiment of the invention. A method of managing compensated education on a computing platform, includes the steps of: providing compensated educational interaction 610 over a computing platform thereby enabling a user to earn compensation for an educational interaction, collecting interaction data 620 regarding the compensated educational interaction from the computing platform thereby generating collected interaction data, and providing an information set 630 based on the collected interaction data thereby allowing an information set receiver to act based on the substance of the information set.

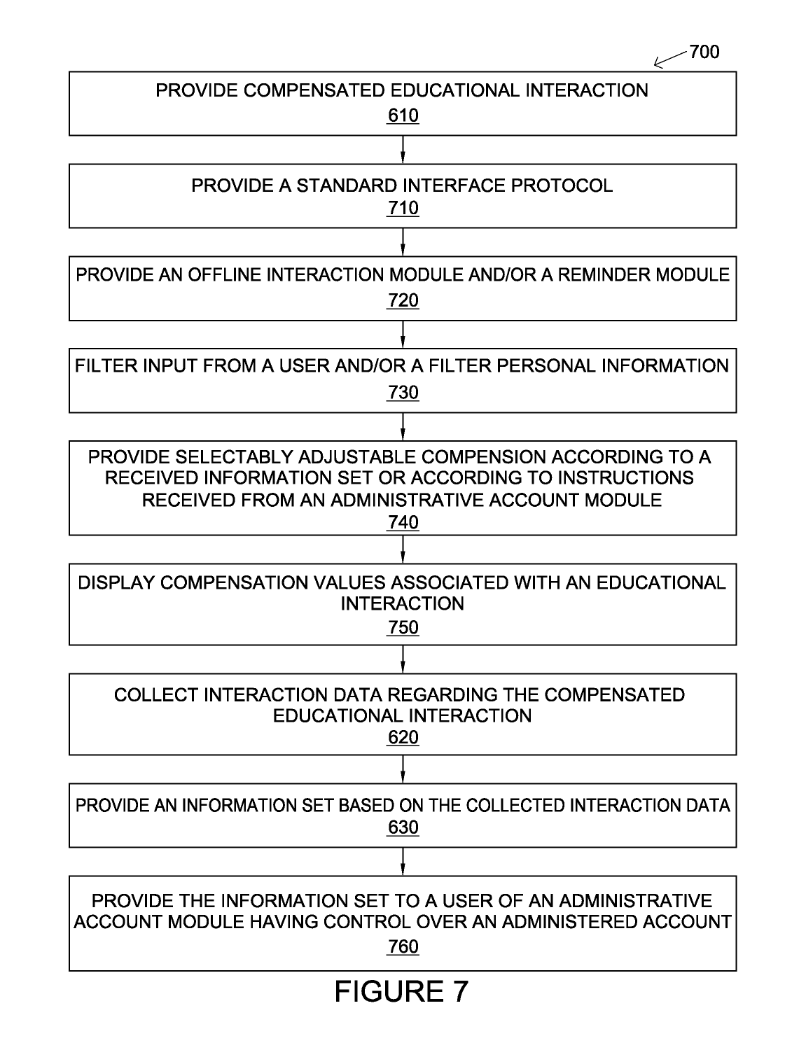

FIGS. 7 and 8 illustrate flowchart and block diagrams of a system and method of managing compensated education according to one embodiment of the invention. In particular, FIG. 7 is a flowchart of a method for managing compensated education, according to one embodiment of the invention. In a related manner, FIG. 8 is a block diagram of a system of managing compensated education, according to one embodiment of the invention. Providing compensated educational interaction 610 may further include providing a standard interface protocol 710, such as content protocol module 818. Content protocol module 818 ought to be configured to permit third-party network content 124 to be used by user 130 such that user 130 may be compensated for interactions therewith. By way of example, user 130 may play an educational game produced by a third-party. The third party educational game may be interfaced through content control protocol module 818, or a like module, and then provided through educational games module 814. A similar interaction of modules would occur with any third-party content.

The step of providing an information set 620 may further include providing the information set to a user of an administrative account 760 module 826 having control over an account module 828 of the user from whose interactions generated the information set. In one embodiment user administrator 132 may be a parent of user 130 who is the parent's child. Providing the information set to administrative account 760 may allow the parent to monitor their child's educational interaction and/or progress.

The step of providing compensated educational interaction 610 may include providing an offline interaction 720 module 816 configured to permit user 130 to register offline educational interactions and be compensated thereby. In a non-limiting example, offline interaction may include school work, physical fitness activities, viewing television programs, and performing chores. The offline interaction module may further include a reminder module configured to remind a user to perform a specific offline activity.

The administrative account module 824 may include a messaging module 826 configured to permit user administrator 132 to utilize administrative account module 824 to deliver a message to an administered account using messaging module 826. Thus, in one embodiment, a parent, using an administrative account, may deliver a message to a child who has a user account. A parent may want to send a variety of messages such as an encouraging message or may want communicate emotional attachment to a child. Messaging module 828 may be utilized to in such a manner. Additionally, the information set may include a suggested message to be delivered by messaging module 826. Thus collected data is used to suggest messages that may be appropriate to the user. For example, in one embodiment, compensated education system 120 may suggest that a parent send their child an encouraging message about an educational subject if the child is struggling in the educational subject, or similarly may suggest a message of pride or accomplishment if the child excels in an educational subject.

The step of providing compensated educational interaction 610 over a computing platform may further include filtering input 730 from a user thereby protecting the user from harmful interaction. There may be a multitude of data that ought not to be collected from user 130, and such filtering may be performed by filtering module 830. One type of data that ought not to be collected is personal information. Personal information filtering module 832 is provided to filter personal information 730.

The step of providing compensated educational interaction 610 may further include a plurality of educational interactions each having adjustable compensation which may be selected. Compensation education system 120 may adjust compensation for a given educational interaction based on a received information set. A user administrator 132 may want to provide incentive for a user 130 to perform certain types of educational interaction. For example, in one embodiment, a parent may want to provide incentive for a child to perform math type interaction. Compensated education system 120 may on its own also alter compensation based on a received information set.

Compensated education system 120 includes: compensation module 802, data collection module 820, and data distribution module 822. Compensation module 802 is configured to provide compensated educational interaction 610 thereby enabling a user to earn compensation for an educational interaction. As user 130 interacts with compensated education system 120 user 130 earns virtual tokens 210 while they are educated.

Data collection module 820 communicates with compensation module 802 and is configured to collect interaction data 620 regarding the compensated educational interaction provided by compensation module 802 thereby generating collected interaction data. As user 130 interacts with compensated education system 120 data is collected about the interaction. Data distribution module 822 is in communication with data collection module 820 and is configured to provide an information set 630 based on the collected interaction data collected through data collection module 820 thereby allowing an information set receiver to act based on the substance of the information set. This collected data 510 may be later distributed to interested parties, including but not limited to: user administrator 132 (which in one embodiment may be a parent), user 130 (which in one embodiment may be a child), and vendor 122.

In one embodiment, compensation module 804 may be one of the following modules: a virtual bank module 804, a virtual investment module 806, a virtual auction module 808, an educational audio/video module 810, an offline interaction module 812, an educational games module 814, and a content protocol module 818. All of the modules shown within 802 may be used by user 130 to interact with compensated education system 120 and thus be compensated for educational interaction.

Data distribution module 820 may provide the collected interaction data to an administrative account module 824 in communication with the compensation module 802. This allows user administrator 132 to get feedback regarding the educational interaction of the administered account of user 130. In one embodiment a parent receives feedback regarding the educational interaction of the child with compensated education system 120.

One or more of the following features may also be included. Offline interaction module 812 may further include a reminder module configured to remind a user to perform a specific offline activity. Administrative account module 824 may further include messaging module 826 configured to permit user administrator 132 of administrative account module 826 to deliver a message to an administered account. Compensation module 802 may further include filtering module 830 configured to filter input from a user thereby protecting the user from harmful interaction.

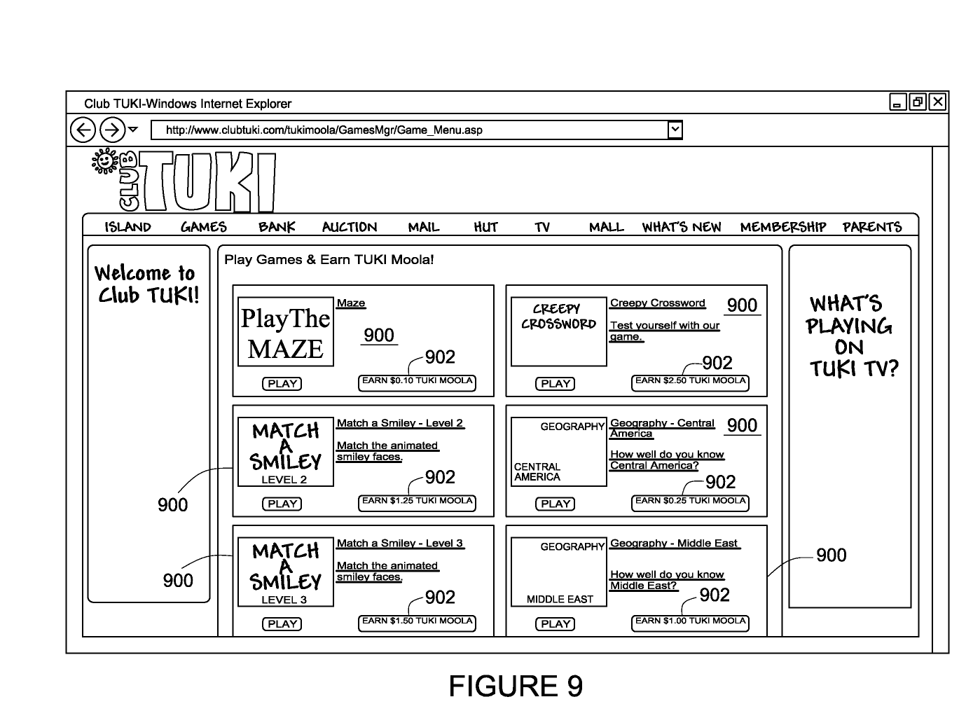

FIG. 9 illustrates an exemplary screen-shot of a user interface for selecting educational interactions in a system for managing compensated education, according to one embodiment of the invention. In particular, it displays a compensation value 902 in association with a displayed activation module 900 configured to initiate an associated compensated educational interaction.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

It is further envisioned the system and method of educating and network interaction while collecting data may include a variety of trade names, trademarks, and/or graphical illustrations with the regard to the system and method. In a non-limiting example, the one or more tokens may include trademark, trade name and/or graphical illustrations. Some non-limiting examples of token trade names/marks include: TukiMoola, Tuki bucks, Club tukimoola, Tuki tunes, tuki video, etc.

It is also envisioned that the system and method may be incorporated into and/or accessible via mobile communication devices (MCDs). The MCD may be any type and/or kind of MCD contemplated in the art, such as but not limited to, cell phones, pages, PDAs, laptops, handheld computers, smart-phones, and/or so forth. In a non-limiting example, a user may be able to download and/or incorporated the system and method and its features/modules/etc. into his or her MCD, thereby enabling him or her to check the virtual bank, check his or her virtual investment portfolio, view his or her email, status of an auction, and/or so forth. The system and method may be accessible and/or downloadable via the user's MCD service, compensated education system 120, and/or other 3^{rd} parties.

It is expected that there could be numerous variations of the design of this invention. An example is that there may be multiple web/network pages which include hyperlinks, graphical user interfaces, designs, graphics, etc. which may heighten the ease of use and/or attractiveness for one or more users.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1) A method of managing compensated education on a computing platform, comprising the steps of:
a) providing compensated educational interaction over a computing platform thereby enabling a user to earn compensation for an educational interaction;
b) collecting interaction data regarding the compensated educational interaction from the computing platform thereby generating collected interaction data; and
c) providing an information set based on the collected interaction data thereby allowing an information set receiver to act based on the substance of the information set.

2) The method of claim 1, wherein the step of providing compensated educational interaction further includes providing a standard interface protocol configured to permit a third-party to provide educational content to the user over the computing platform such that the user may be compensated for interactions therewith.

3) The method of claim 1, wherein the step of providing an information set further includes providing the information set to a user of an administrative account module having control over an account module of the user from whose interactions generated the information set.

4) The method of claim 1, wherein the step of providing compensated educational interaction includes providing an offline interaction module configured to permit a user to register offline educational interactions and be compensated thereby.

5) The method of claim 4, wherein the offline interaction module further includes a reminder module configured to remind a user to perform a specific offline activity.

6) The method of claim 3, wherein the administrative account module includes a messaging module configured to permit a user of the administrative account module to deliver a message to an administered account.

7) The method of claim 6, wherein the information set includes a suggested message to be delivered by the messaging module.

8) The method of claim 1, wherein the step of providing compensated educational interaction over a computing platform further includes filtering input from a user thereby protecting the user from harmful interaction.

9) The method of claim 8, wherein the step of filtering input from a user further includes a personal information filtering module configured to identify personal information input from the user and filter such.

10) The method of claim 1, wherein the step of providing compensated educational interaction further includes a plurality of educational interactions each having a selectably adjustable compensation.

11) The method of claim 10, wherein the step of providing compensated educational interaction further includes altering compensation for an educational interaction according to a received information set.

12) The method of claim 10, wherein the step of providing compensated educational interaction further includes altering compensation for an educational interaction for an administered account module according to an instruction received from an administrative account module.

13) The method of claim 1, wherein the step of providing compensated educational interaction includes displaying a compensation value in association with a displayed activation module configured to initiate an associated compensated educational interaction.

14) A computing system for managing compensated education of users, comprising:
a) a compensation module configured to provide compensated educational interaction thereby enabling a user to earn compensation for an educational interaction;
b) a data collection module in communication with the compensation module and configured to collect interaction data regarding the compensated educational interaction provided by the compensation module thereby generating collected interaction data; and
c) a data distribution module in communication with the data collection module and configured to provide an information set based on the collected interaction data collected through the data collection module thereby allowing an information set receiver to act based on the substance of the information set.

15) The system of claim 14, wherein the compensation module is a module chosen from a set consisting of: a virtual bank module, a virtual investment module, a virtual auction module, an educational audio/video module, an offline interaction module, an educational games module, and a content protocol module.

16) The system of claim 14, wherein the data distribution module provides the collected interaction data to an administrative account module in communication with the compensation module.

17) The system of claim 15, wherein the offline interaction module further includes a reminder module configured to remind a user to perform a specific offline activity.

18) The system of claim 16, wherein the administrative account module further includes a messaging module configured to permit a user of the administrative account module to deliver a message to an administered account.

19) The system of claim 14, wherein the compensation module further includes a filtering module configured to filter input from a user thereby protecting the user from harmful interaction.

20) A computer-readable medium comprising computer-executable instructions that, when executed, direct a computer to perform the steps comprising:
a) providing compensated educational interaction, including providing a standard interface protocol configured to permit a third-party to provide educational content to the user, thereby enabling a user to earn compensation for an educational interaction;
b) collecting interaction data regarding the compensated educational interaction from the computing platform thereby generating collected interaction data; and
c) providing an information set based on the collected interaction data thereby allowing an information set receiver, including a user of an administrative account module having control over an account module of the user from whose interactions generated the information set, to act based on the substance of the information set.
